(19) United States
(12) Patent Application Publication
(10) Pub. No.: US 2016/0167329 A1
(43) Pub. Date: Jun. 16, 2016

(54) HYDRAULIC PRESS

(71) Applicant: MELCHOR GABILONDO, S.A., Berriz (Vizcaya) (ES)

(72) Inventor: Antonio Martinez Martinez, Berriz (Vizcaya) (ES)

(21) Appl. No.: 14/892,545

(22) PCT Filed: May 20, 2014
(86) PCT No.: PCT/ES2014/070412

§ 371 Date: Dec. 29, 2015

(30) Foreign Application Priority Data
May 20, 2013 (ES) U201300460
May 20, 2013 (ES) U201300461
May 20, 2013 (ES) U201300462

(51) Int. Cl. B30B 1/32; B25H 1/12; B25H 1/16; B30B 15/04

(52) U.S. Cl. CPC B30B 1/326; B30B 15/04; B25H 1/12; B25H 1/16

(57) ABSTRACT

Hydraulic press which comprises:
a structure which comprises at least one support for supporting the hydraulic press on the floor,
a working table intended to house a set of pieces from which at least one piece is separated or removed by means of a compressive force exerted by the hydraulic press.
a collection area positioned below the working table receiving the piece separated or removed from the set, and
a damper connected between the working table and the structure, capable of being expanded to cause the ascent of the working table with respect to the structure and is capable of being compressed to allow the retained descent of the working table with respect to the structure.

### TECHNICAL SECTOR

The invention relates to a hydraulic press of the type used in different industrial sectors for manipulation tasks of pieces.

### PRIOR ART

In the prior art, the hydraulic press is known, which is a basic tool widely used in different industrial sectors for works or manipulation tasks of pieces by means of the application of pressing forces or loads. These manipulation tasks include operations for bending or straightening pieces, introducing or removing a piece with respect to another, joining or separating pieces and introducing or removing bracket bearings.

Essentially, a hydraulic press has a closed hydraulic circuit in which a hydraulic fluid, commonly a type of oil suitable for this use is displaced by way of the different components of the hydraulic circuit. An energy generating device, usually a hydraulic pump, exerts a pressure on the hydraulic fluid. The energy contained in the hydraulic fluid is provided to a hydraulic actuator or cylinder, which is provided with an interior piston. The piston exerts the force necessary for the operation to be carried out on the piece to be manipulated, this pressing force or load being of a large value. The high working forces involved means that the operation of the hydraulic press for manipulation tasks of pieces is not exempt from various safety problems. The operation of the hydraulic press also involves risks for the operator related to the fact that the pieces involved have a certain mass and are subject to said high forces. Thus, prior to proceeding with the operation of the hydraulic press, it is essential that certain precautionary measures are always taken such as securing the perimeter of the working space in which the hydraulic press is located and the use of protection glasses or a safety suit.

Moreover, the hydraulic presses are usually provided with a working console or table provided with some static element or seat on which the piece to be manipulated is placed and fixed. Prior to the placement and fixing of the piece, the working table of the hydraulic press must be positioned at a suitable working height.

In the known hydraulic presses, in which the working table is regulatable to different heights, the placement of the working table at the desired height is usually carried out with aid of a winch. The winch is a known mechanism which comprises a rotatable roller and a cable wound around the roller at one of the ends thereof. The other end of the cable is connected to the working table such that the working table is pulled by the cable during an ascent or descent operation. The winch can be actuated manually by means of, for example a crank, in order to cause the ascent or the descent of the working table to the suitable working height. Once positioned at the desired height, the working table is fixed to the metallic structure of the hydraulic press. In the hydraulic floor presses, said structure or chassis generally has two lower supports, two vertical lateral columns and an upper bridge in which the hydraulic cylinder is housed. The working table is supported on two support axes or elements previously placed in two holes of the lateral columns of the structure at the working height selected. The two axes must always be placed at a level in a suitable position according to the operation to be effected and the operator of the hydraulic press must ensure that the working table rests firmly on the same.

Definitively, the working tables and the hydraulic presses in general are very heavy elements which must be operated with great precaution. In this sense, the adjustment of the height of the working table by means of winches constitutes an inconvenient and slow system. Although hydraulic presses are also known, which do not have winches, the operator of these types of presses must always require the help of other individuals to place the working table in the position thereof each time the working height has to be modified.

Thus, the object of the invention is to facilitate the work of the operators who use the hydraulic press so that said work can be carried out in a more secure manner and with greater convenience. Moreover, the object of the invention is to facilitate the manipulation of the working table to achieve the mentioned object.

In addition, in hydraulic presses, the hydraulic pump is usually specifically designed for the actuation of the hydraulic cylinder. Moreover, the actuation of the hydraulic pump can be of different types, the use of manual, pneumatic or electric actuation pumps being very frequent according to the working velocity required.

In hydraulic presses equipped with hydraulic pumps with pneumatic or manual actuation, the mechanical power is commonly transmitted to the pump by means of the actuation of manual control levers. In order to avoid unsuitable manual actuations or other undesired circumstances, a safety valve placed at the discharge of the hydraulic pump allows the hydraulic fluid to return to the tank in the case that the safety conditions necessary for the operation of the hydraulic pump are not present, for example due to excessive pressure in the hydraulic circuit.

The functioning of a manual hydraulic press usually begins when the operator actuates a manual control lever. Said actuation causes the hydraulic pump to intake the hydraulic fluid from the tank and discharges it to the hydraulic cylinder. Upon being pressed by the hydraulic fluid, the hydraulic cylinder advances in the direction of the piece to be manipulated and exerts a compressive working force on said piece. With the compression or manipulation work finished, a discharge of the hydraulic circuit is necessary to cause the backward movement of the hydraulic cylinder. This discharge operation is very commonly implemented by means of a discharge valve actuated by means of a manual flywheel or a manual lever. The actuation of the discharge valve allows the return of the hydraulic fluid towards the tank, thereby causing the backward movement of the hydraulic cylinder which is ready for a new manipulation task.

Moreover, the object of the invention is the design of an alternative hydraulic press to the existing ones, the operation of which is simpler and more convenient for the operator of the hydraulic press in comparison to the existing hydraulic presses. Additionally, at least one embodiment must be applicable to hydraulic presses in which the actuation of the hydraulic pump of the hydraulic circuit is of the manual or pneumatic type.

### BRIEF DESCRIPTION OF THE INVENTION

The hydraulic press, which the invention presents, comprises a structure which comprises at least one support for supporting the hydraulic press on the floor, a working table intended for housing a set of pieces from which at least one piece is separated or removed by means of a compressive force exerted by the hydraulic press, a collection area positioned below the working table for receiving the piece separated or removed from the set and a damper connected between the working table and the structure, wherein the damper is capable of being expanded to cause the ascent of the working table with respect to the structure and is capable of being compressed to allow the retained descent of the working table with respect to the structure.

In one preferred embodiment, the hydraulic press also comprises a tank for storing a hydraulic fluid, a hydraulic pump for causing the advance of a hydraulic cylinder towards a working area, and a discharge pedal for causing the backward movement of the hydraulic cylinder, wherein the discharge pedal is situated in a lower area of the structure, wherein said lower area is delimited by the supports and is accessible by the foot of an operator who is standing in front of the hydraulic press.

Therefore, the object of the invention is a hydraulic press, which, like conventional hydraulic presses used for manipulation tasks of pieces, comprises a working table intended to house a set of pieces from which at least one piece is separated or removed by means of a compressive force exerted by the hydraulic press. The hydraulic press according to the invention also has the particularity of comprising a collection area positioned below the working table, said collection area being capable of receiving the piece separated or removed from the set.

In this way, the piece separated or removed by means of the compressive force exerted by the hydraulic press is retained in the collection area, thereby avoiding the falling thereof to the floor. This characteristic allows the operator to carry out the separation or removal operation in a secure manner since the risk of the removed piece being able to impact his foot is minimized when it exits projected towards the floor. Once the separation or removal task has finished, the separated or removed piece can be subsequently withdrawn from the collection area of the hydraulic press in a more convenient manner for the operator, who does not have to bend in order to collect the separated or removed piece from the floor.

Another advantage derived from the fact that the separated or removed piece is retained in the collection area is that it avoid the piece, upon falling from the height of the working table to the floor, suffering undesired collisions and consequently damage.

Additionally, the hydraulic press according to the invention facilitates the tasks of cleaning and maintaining the hydraulic press since the collection area also retains part of the dirt which is generated in the tasks of separation or removal.

In another preferred embodiment of the hydraulic press, the working table comprises at least one connection element which allows the mounting of the collection area on the working table itself. This characteristic which allows the collection area to be incorporated in the working table is especially advantageous in hydraulic presses equipped with a working table regulatable in height: in these types of hydraulic presses, when the collection area is incorporated in the working table regulatable in height, both components, working table and collection area, are displaced together: in this way, the need to adapt or position the collection area again each time the height of the working table is modified is avoided.

Preferably, the collection area is implemented in an element separable from the hydraulic press. Preferably, the separable element is a tray.

Preferably, the collection area comprises at least one housing which allows accessories or tools to be housed.

Preferably, the working table comprises at least one connection element which allows the mounting of the collection area, wherein said collection area is implemented in a tray separable from the hydraulic press, and wherein the collection area also comprises at least one housing which allows accessories or tools to be housed.

Moreover, a hydraulic press is the object of the invention, for use in mechanical workshops for manipulation tasks of pieces, which comprises a structure and a working table intended to house at least one piece intended to be manipulated by means of the application of a compressive force exerted by the hydraulic press wherein the working table has a position regulatable in height with respect to the structure. The hydraulic press according to the invention has the particularity of comprising at least one damper connected between the working table and the structure, wherein the damper is capable of being expanded to cause the ascent of the working table with respect to the structure and is capable of being compressed to allow the retained descent of the working table with respect to the structure.

In this way, the regulation of the height of the working table can be implemented in a very convenient manner for the operator, owing to the fact that the damper allows the ascent and descent of the working table to be controlled with minimum effort on the part of the operator. The damper also has the advantage of being capable of supporting the weight of the working table. This additional advantage coupled with the capacity to retain the descent of the working table means that the manipulation of the working table for the regulation of the height thereof can be carried out in a secure manner for the operator of the hydraulic press.

Additionally, the incorporation of the damper makes it possible for the lifting movement of the working table to be balanced and moreover, the retention in the descent contributes to the fact that the working table descends at a controlled speed. Owing to these technical characteristics, the hydraulic press according to the invention has another important advantage over the hydraulic presses in which certain undesired inclinations and decompensations are frequently produced upon positioning the working table by means of conventional height regulation systems based on manual manipulation or winches; these inclinations and decompensations are significantly minimized in the hydraulic press according to the invention, owing to the fact that the damper provides balanced ascent and descent movements.

Preferably, the structure comprises two opposed sides, the working table extending from one side to the other such that opposed sides of the working table are aligned with the opposed sides of the structure and wherein the hydraulic press comprises a damper on each side of the structure, connected between the side of the structure and the side aligned with the working table.

Preferably, the damper is a gas cylinder provided with a body from which a longitudinally displaceable rod projects, wherein the body is connected to the working table while the rod is connected to the structure.

Preferably, the hydraulic press comprises at least one fixing element for fixing the working table to the structure.

Preferably, the damper is a damper with a lock.

Preferably, the structure comprises a fore frontal face and a rear frontal face between which a space is delimited within which the working table is placed at a regulatable height.

Preferably, the working table comprises a fore frontal plate; a rear frontal plate and at least one transversal lateral upper plate arranged between the fore frontal plate and the rear frontal plate, wherein the damper is connected to said transversal lateral upper plate. Preferably, the structure comprises at least one transversal lateral lower plate for connecting the damper, such that the damper is connected between the transversal lateral upper plate of the working table and the transversal lateral lower plate of the structure, wherein said transversal lateral lower plate can be placed in a variable position of the structure. Preferably, the transversal lateral upper plate and the transversal lateral lower plate are parallel.

Moreover, the object of the invention is a hydraulic press, intended to be used in mechanical workshops for general work of manipulating pieces, which comprises a chassis or structure which, in turn, comprises at least one support for supporting the hydraulic press on the floor, and which also comprises a hydraulic cylinder and a hydraulic pump connected by means of a closed hydraulic circuit. The hydraulic cylinder, like in other known hydraulic presses, is capable of effecting an advance movement in a direction P towards a working area and, once positioned in said working area, is capable of exerting a compressive force intended to effect manipulation work on a piece placed in the working area. The hydraulic pump causes the actuation of the hydraulic cylinder and the advance thereof in the direction P. The hydraulic press according to the invention is characterized in that it comprises a discharge pedal to cause a backward movement of the hydraulic cylinder in a direction contrary to the direction P and in that said discharge pedal is situated in a lower area of the structure, said lower area being delimited by the supports. Additionally, the lower area of the structure of the hydraulic press according to the invention has the particularity of being accessible by the foot of an operator who is standing in front of the hydraulic press.

Thanks to the incorporation of the discharge pedal, the operator of the hydraulic press can carry out the discharge operation of the hydraulic circuit in a very convenient manner by simply actuating the discharge pedal with his foot. The operational convenience of the hydraulic press according to the invention is increased by the fact that by actuating the discharge pedal with his foot the operator has his hands free while carrying out the discharge operation. Additionally, the location of the discharge pedal in the lower area of the structure, easily accessible by the foot of the operator, is optimal for greater ease and convenience for actuating the pedal.

Preferably, the tank is situated in the lower area of the structure and the discharge pedal is situated in a location adjacent to the tank (30).

Preferably, the hydraulic pump is situated in the lower area of the structure of the hydraulic press. This characteristic contributes to simplifying the design of the hydraulic press as well as facilitating the mounting of the same since it allows supports and other additional elements for connecting the hydraulic pump to be dispensed with which are required in hydraulic presses where the hydraulic pump is placed in an intermediate area of the structure or in the upper area of the structure. This reduction of components also involves a reduction of the cost for maintenance of the hydraulic press.

Optionally, the hydraulic press comprises different pedals for the actuation of the hydraulic pump, said pedals being situated in the lower area of the structure. The presence of said pedals allows manual levers for the operation of the hydraulic press, for the actuation both of the discharge and of the pumping, to be completely dispensed with, with the result that the operator can have his hands free at all times to carry out other operations, this advantage assuming not only greater convenience but also greater security and speed in the operation of the hydraulic press.

The hydraulic press thus preferably comprises a working pedal for actuating the hydraulic pump, wherein said working pedal is situated in the lower area of the structure. Furthermore, according to the previous embodiment, the hydraulic pump is preferably situated in the lower area of the structure, wherein the discharge pedal is situated in the left part of the lower area, separated from the hydraulic pump, while the working pedal is situated in the right part of the lower area in a location adjacent to the hydraulic pump.

Alternatively, the hydraulic press can comprise an inching pedal for actuating the hydraulic pump causing the partial advance of the hydraulic cylinder towards the working area, wherein said inching pedal is situated in the lower area of the structure. In addition to the previous alternative embodiment, the hydraulic pump can be situated in the lower area of the structure, and the discharge pedal in the left part of the lower area, separated from the hydraulic pump, while both the inching pedal and the working pedal are situated in the right part of the lower area in locations adjacent to the hydraulic pump.

In embodiments of the invention in which the hydraulic press is equipped with pedals for actuating the hydraulic pump and in addition the hydraulic pump is also situated in the lower area of the structure, the connection between the actuation pedals and the hydraulic pump may be simple and direct due to the proximity thereof since it is located in the lower area of the structure. In this way, it is possible to dispense with connection elements of certain length, for example rods, necessary for transmitting the pressure exerted by the operator on the actuation pedals to the hydraulic pump, as occurs with conventional hydraulic presses in which the hydraulic pump is placed in an intermediate or upper area of the structure at a great distance from the actuation pedals.

### BRIEF DESCRIPTION OF THE FIGURES

The details of the invention are observed in the figures which are enclosed, these are not intended to be limitative to the scope of the invention:

FIG. 1 shows a perspective of an embodiment of the hydraulic press according to the invention.

FIG. 2 shows a perspective of an embodiment of the hydraulic press according to the invention.

FIG. 3 shows a perspective of an embodiment of the hydraulic press according to the invention in which the collection area is placed in the usual position thereof.

FIG. 4 shows a perspective of the hydraulic press of FIG. 3, wherein the collection area is visualized separated from the hydraulic press.

FIG. 5 shows a perspective of a hydraulic press known in the prior art, wherein the height of the working table is regulated by means of a winch.

FIG. 6 shows a perspective of an embodiment of the hydraulic press according to the invention in which the damper is detailed.

FIG. 7 shows a perspective of an embodiment of the hydraulic press according to the invention in which the actuation pedals are detailed.

### DETAILED DESCRIPTION OF THE INVENTION

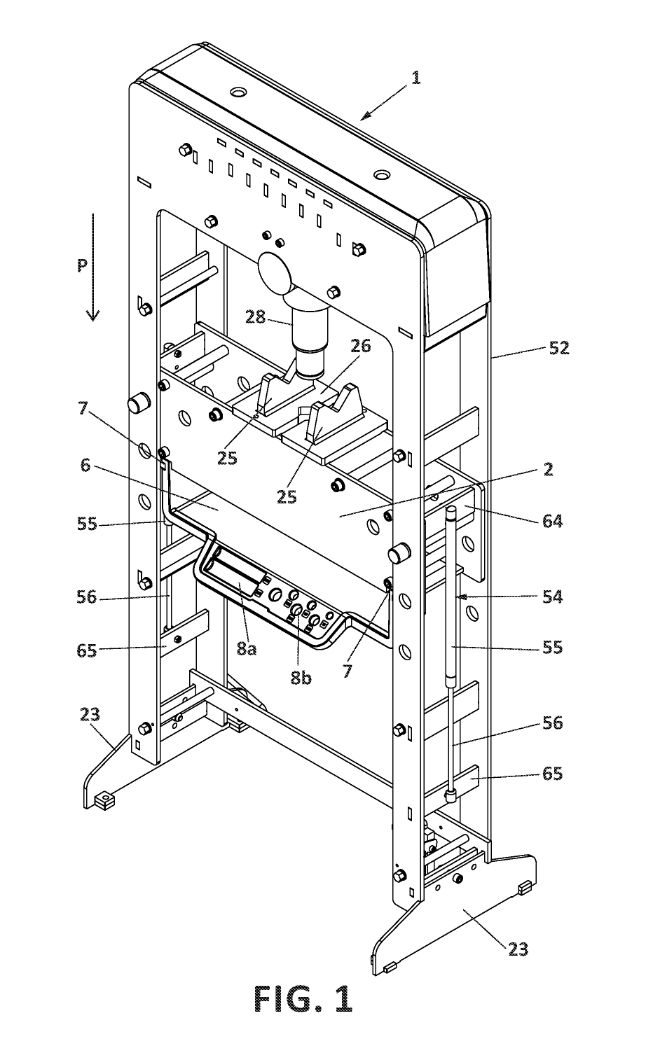

FIG. 1 shows an embodiment according to the present invention wherein the hydraulic press (1) comprises the structure (52) which comprises at least one support (23) for supporting the hydraulic press (1) on the floor, the working table (2, 53, 24) intended to house a set of pieces from which at least one piece is separated or removed by means of a compressive force exerted by the hydraulic press (1), the collection area (6) positioned below the working table (2, 53, 24) for receiving the piece separated or removed from the set, and the damper (54) connected between the working table (2, 53, 24) and the structure (52), wherein the damper (54) is capable of being expanded to cause the ascent of the working table (2, 53, 24) with respect to the structure (52) and is capable of being compressed to allow the retained descent of the working table (2, 53, 24) with respect to the structure (52).

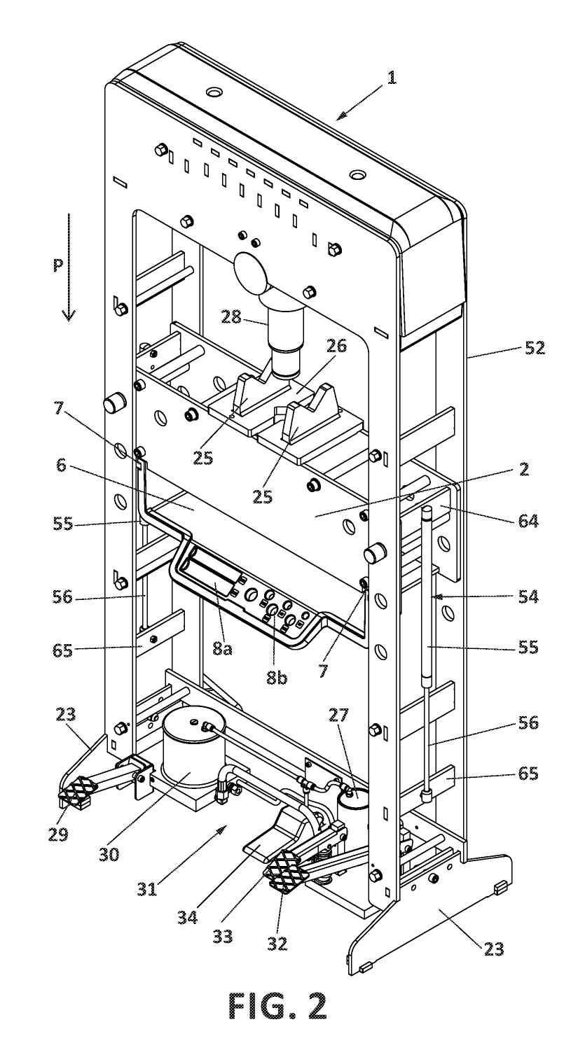

FIG. 2 shows the embodiment shown in FIG. 1 wherein the hydraulic press (1) also comprises the tank (30) for storing a hydraulic fluid, the hydraulic pump (27) for causing the advance of a hydraulic cylinder (28) towards a working area (26) and the discharge pedal (29) for causing the backward movement of the hydraulic cylinder (28), wherein the discharge pedal (29) is situated in a lower area (31) of the structure (52), wherein said lower area (31) is delimited by the supports (23) and is accessible by the foot of an operator who is standing in front of the hydraulic press (1).

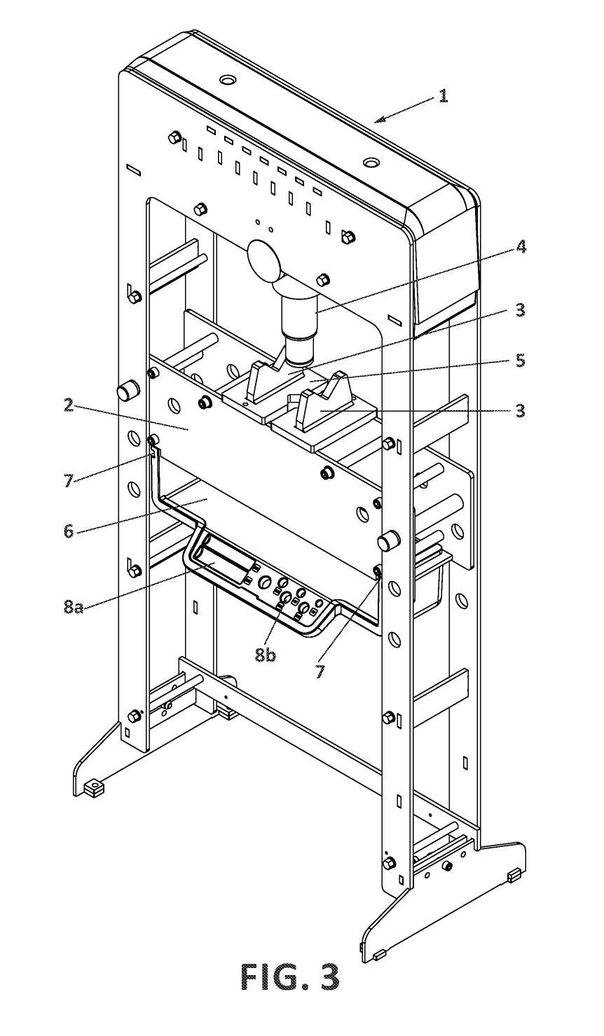

FIG. 3 shows a perspective of an embodiment of the hydraulic press (1) according to the invention, wherein said perspective is focused on the collection area (6) of pieces. As can be seen in said figure, the hydraulic press (1) comprises, like other hydraulic presses used for manipulation tasks of pieces, a working console or table (2) intended to house a set of pieces from which at least one piece is separated or removed by means of the application of a compressive force exerted by the hydraulic press (1). In the embodiment depicted in FIG. 1, the working table (2) also comprises two static elements or seats (3) which serve to support the set of pieces to be manipulated. A hydraulic cylinder (4) is the element of the hydraulic press which exerts the compressive force on the set of pieces. In one common separation task of pieces, the working table (2) is initially positioned at a suitable working height, manually or by means of a winch. The set of pieces to be manipulated (not depicted in the figure) is then generally placed on the seats (3) and is fundamentally arranged within a working area (5) between the working table (2) and the hydraulic cylinder (4). Subsequently, the hydraulic press (1) is actuated by the operator, causing the descent of the hydraulic cylinder (4). The hydraulic cylinder (4), after being positioned in the working area (5), applies the pressure or force required for causing the separation or removal of the piece from the set of pieces.

The hydraulic press (1) according to the invention has the particularity of incorporating a collection area (6) positioned below the working table (2), wherein said collection area (6) is capable of receiving the piece separated or removed from the set of pieces manipulated by the hydraulic press (1). In this way, the piece separated or removed is retained in the collection area (6), avoiding said piece falling to the floor causing possible injury to the operator or the piece suffering damage upon colliding with the floor. The location of the collection area (6) in a position lower than the working table (2) allows the separated piece to be collected, utilizing the force of gravity, providing the operator with a greater degree of freedom and convenience for carrying out other manual operations.

Preferably, the working table (2) of the hydraulic press (1) comprises at least one connection element which allows the mounting of the collection area (6). Said connection element makes possible the placement of the collection area (6) in a lower location very close to the working table (2), thereby optimizing the collection of the separated piece. This characteristic is also especially advantageous in hydraulic presses equipped with a working table regulatable in height, like the one shown in FIG. 1, since it makes it possible for the collection area (6) to be displaced together with the working table (2), the relative arrangement being maintained in an optimal manner between the collection area (6) and the working table (2) when said working table (2) is repositioned at a different height in order to effect another manipulation task. Other embodiments different to that depicted in FIG. 1 stand out, in which the collection area (6) is mounted on another element of the hydraulic press (1) different to the working table (2).

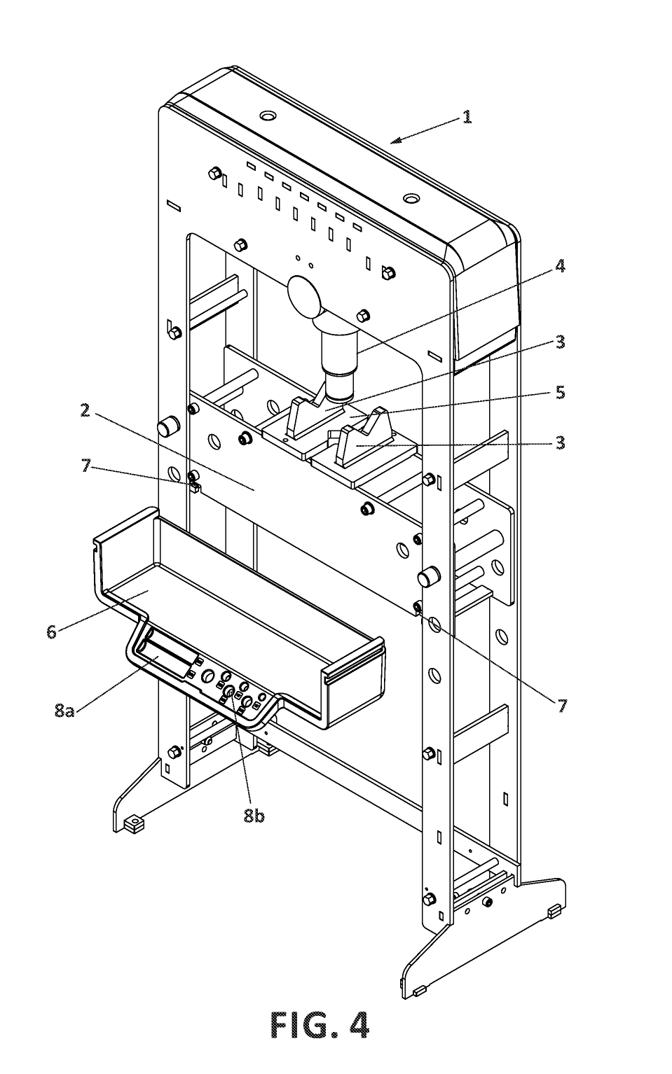

In order to facilitate the mounting and maintenance tasks of the hydraulic press (1), the collection area (6) is preferably implemented in an element separable from the hydraulic press (1), as in the embodiment shown in FIGS. 3 and 4 which respectively show the collection area (6) placed in the usual position thereof and separated from the hydraulic press (1). Specifically, in the embodiment depicted, said separable element in which the collection area (6) is implemented is a tray and the connection element which allows the mounting of said tray in the working table (2) are tabs (7) formed in the frontal plates of the working table (2). Owing to these tabs (7), the tray can be extended and inserted with ease.

Optionally, the collection area (6) comprises at least one housing (8a, 8b) via which it is possible to house, deposit or store different accessories of the hydraulic press (1) or tools, these housings (8a, 8b) being very useful for the operator of the hydraulic press (1) since a space is commonly required so that said accessories are easily accessible. The housings (8a, 8b) can adopt different forms to be adapted to different accessories.

The form of the collection are (6) of the hydraulic press (1) according to the invention is not limited to the specific embodiment depicted in the figures, being able to adopt other forms.

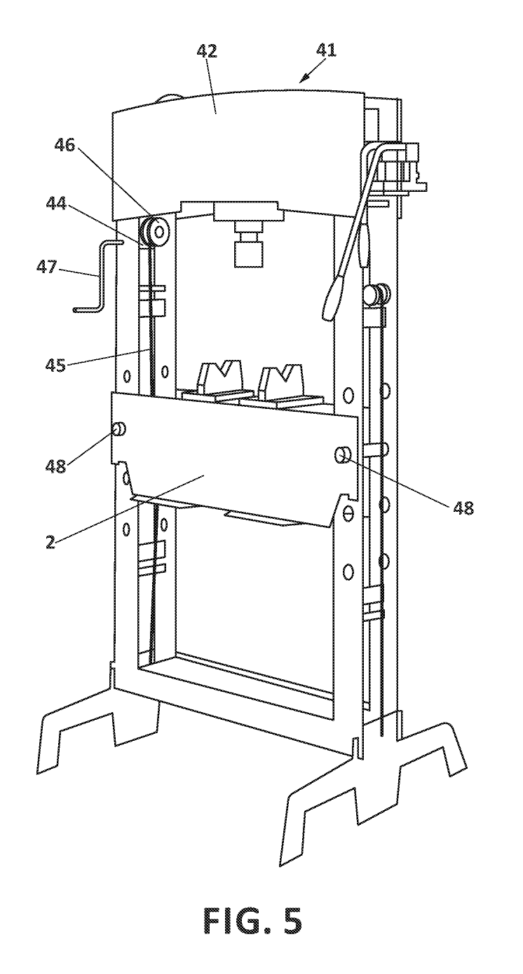

FIG. 5 shows a hydraulic press (41), known in the prior art, which comprises a structure (42) and a working table (2) intended to house a piece to be manipulated by the hydraulic press (41). The hydraulic press (41) shown in FIG. 5 is provided with a winch (44) for the placement of the working table (2) at the desired height. The winch (44) is provided with a cable (45) and a roller (46) for collecting said cable (45) at one of the ends thereof; the cable (45) is arranged around the structure (42) and is guided around said structure (42) by means of different additional rollers such that the end of the cable (45) opposed to the roller (46) is connected to the working table (2) and such that the weight of the working table (2) is held by the cable (45). The winch (44) is actuated by means of a handle (47) for causing the winding or extension of the cable (45) around the roller (46) and the consequent ascent or the descent of the working table (2) to the suitable working height. Additionally, the working table (2) rests on two support elements (48) which support the weight of the same when the working table (2) is finally positioned. This adjustment system of the height of the working table (2) is inconvenient and slow since it requires quite some force on the part of the operator to manipulate the winch (44). Moreover, it forces the operator to increase the safety measures to ensure that all the fastening elements of the working table (2), cable (45) and support elements (48) primarily, are in good order and correctly adjusted at all times.

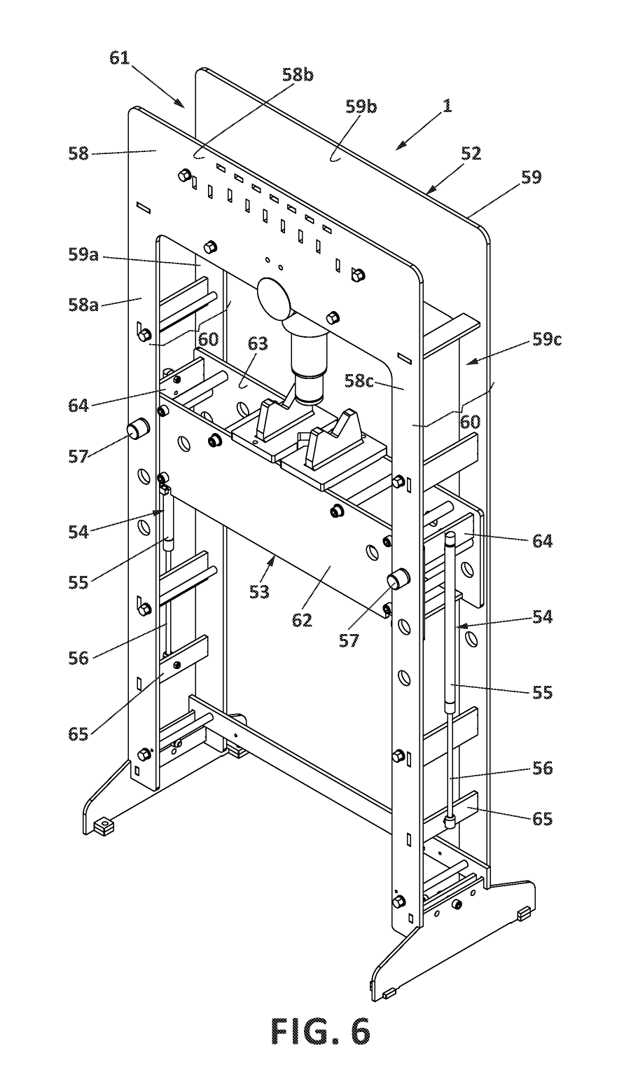

FIG. 6 shows an embodiment of a hydraulic floor press (1) according to the invention in which the damper is observed which allows the regulation of the height of the working table. As is observed in said figure, the hydraulic press (1) comprises a structure (52) and a working table (53) intended to house at least one piece intended to be manipulated by means of the application of a compressive force exerted by the hydraulic press (1). The position of the working table (53) is regulatable in height with respect to the structure (52).

The hydraulic press (1) according to the invention is characterized in that it comprises at least one damper (54) connected between the working table (53) and the structure (52), wherein the damper (54) is capable of being expanded to cause the ascent of the working table (53) and is capable of being compressed to allow the descent of the working table (53) with suitable retention, thereby allowing the height of the working table (53) to be regulated. The controlled compression and expansion of the damper (54) means that the ascent and descent movements of the working table (53) are produced in a gradual, controlled and balanced manner without effort on the part of the operator of the hydraulic press (1). Thus the hydraulic press (1) according to the invention constitutes an alternative which improves the convenience and security with respect to other hydraulic presses with known systems for regulating the height of the working table (53) by means of, for example a winch (44) like the one shown in FIG. 5.

A damper is a device capable of absorbing energy and reducing undesired oscillations of a movement. The hydraulic press (1) of the embodiment depicted in FIG. 6 specifically comprises two dampers (54) each one of which is provided with a body (55) from which a longitudinally displaceable rod (56) projects due to the effect of an existing pressure in the interior of body (55). As can be observed in FIG. 6, the body (55) is the part of the damper (54) which is connected to the working table (53) while the rod (56) is connected to the structure (52). The dampers (54) depicted in FIG. 6 are at maximum expansion, that is to say, the rod being completely displaced outside the body (55) and the working table (53) in the highest possible position thereof. Departing from the situation shown in FIG. 6, the descent of the working table (53) is caused by means of the application of a pushing force towards the floor on said working table (53) by the operator of the hydraulic press (1). This pushing force causes the compression of the dampers (54) such that the rod (56) penetrates inside the body (55) of the corresponding damper (54) and the working table (53) descends at a controlled speed. The ascent of the working table (53) is produced automatically when the application of the pushing force on the working table (53) ceases such that the body (55) is displaced towards the exterior of the rod (56) of the corresponding damper (54), causing the ascent of the working table (53).

The structure (52) of the embodiment of FIG. 6 comprises two opposed sides, the adjacent areas or areas very close to the left and right lateral borders of the structure (52) extending per side. Optionally, the working table (53) extends from one side to the other, such that opposed sides of the working table (53) are aligned with the opposed sides of the structure (52) and such that the hydraulic press (1) comprises a damper (54) on each side of the structure (52). Each damper (54) is connected between the side of the structure (52) and the side with the working table (53) as is observed in the embodiment of FIG. 6. The presence of two dampers (54) with this arrangement optimizes the stability, balance and distribution of forces, thereby improving the robustness of this mechanism for regulating the height of the working table (53). The lateral location of the dampers (54) on the sides also facilitates the mounting and replacement thereof.

Optionally, the damper (54) of the hydraulic press (1) is a gas cylinder. The selection of this type of damper (54) is due to the ease of use, availability and to the good behavior thereof as a counterweight element, the use of dampers of another type also being considered.

In order to engage the working table (53) once it is positioned at the desired working height, optionally, the hydraulic press (1) comprises at least one fixing element (57) for fixing the working table (53) to the structure (52). In the embodiment of FIG. 6, the two fixing elements (57) serve to engage the working table (53) and to avoid the backward movement thereof upwards upon the application of the pushing force of the operator ceasing which makes the working table (53) descend.

Optionally, the damper (54) is a damper with a lock. These types of dampers have an internal mechanism which prevents the compression and/or the expansion of the damper and consequently also prevents the ascent and/or descent of the working table (53). The locking mechanism can be actuated, for example by means of an external lever or a button and be used to engage the working table (53) at any height. Thus, the hydraulic press (1) according to the invention is not limited to the use of dampers (54) without a lock, which, in the absence of an external force, have the capacity to be expanded at any time. It is also possible to incorporate other types of dampers with the mentioned possibility of locking the actuation; as an example, gas cylinders are cited provided with two internal gas chambers and with a movable mechanism which opens or closes the passage of gas between said chambers, dampers of another type also being considered.

In addition, in the embodiment of the hydraulic press (1) depicted in FIG. 6, the structure (52) comprises a fore frontal face (58) and a rear frontal face (59); each one of the fore and rear frontal faces (58, 59) of the structure (52) comprise a left vertical section (58a, 59a), an upper horizontal section (58b, 59b) and a right vertical section (58c, 59c). The two left vertical sections (58a, 59a) and the two right vertical sections (58c, 59c) respectively define both columns (60) to the left and to the right of the structure (52). A space (61) is delimited between the fore frontal face (58) and the rear frontal face (59) comprising the vertical planes which contain the fore and rear frontal faces (58, 59) of the structure (52). Optionally, the working table (53) of the hydraulic press (1) is fundamentally comprised within said space (61) whatever the working height at which it is placed. Owing to this characteristic, the columns (60) of the structure (52) serve to guide the lifting and descending movement of the working table (53), aiding the balancing of the positioning mechanism of the working table (53) and minimizing possible small imbalances which may be produced in the alignment of the damper (54). As can be seen in the embodiment in FIG. 6, not only the working table (53), but the majority of the components of the hydraulic press (1) are situated completely or partially within the space (61) according to an arrangement which constitutes an integral and compact set.

Optionally, the working table (53) comprises a fore frontal plate (62), a rear frontal plate (63) and at least one transversal lateral upper plate (64) for connecting the damper (54). In order to facilitate the connection of the damper (54) to the working table (53), said upper plate (64) is located on one side of the working table (53) between the fore frontal plate (62) and the rear frontal plate (63). In this embodiment shown in FIG. 6, there are two transversal lateral upper plates (64) used for connecting a damper (54) to each side of the working table (53), these transversal lateral upper plates (64) being perpendicular to the fore and rear frontal plates (62, 63) and thereby constituting a working table (53) with robust mounting. Moreover, all the plates (62, 63, 64) of the working table (53) are within the space (61) which makes possible the previously mentioned use of the columns (60) as a guide.

Also optionally, the structure (52) comprises at least one transversal lateral lower plate (65) for connecting the damper (54) such that the damper (54) is connected between the transversal lateral upper plate (64) of the working table (53) and the transversal lateral lower plate (65) of the structure (52). Said transversal lateral lower plate (65) can be placed in a variable position of the structure (52). In the embodiment depicted, the two transversal lateral lower plates (65) are connected to the columns (60) of the structure (52), allowing the height at which they are placed to be modified; this characteristic allows other dampers of different length and/or nominal force to be connected which, in turn, makes possible the use of the hydraulic press (1) with other tables of different weight.

Optionally, the transversal lateral upper plate (64) and the transversal lateral lower plate (65) are parallel for a greater ease of mounting and simplicity of the design of the structure (52). This characteristic also ensures a suitable balancing in the ascent and descent movements for regulating the height of the working table (53).

The connection of the damper (54) by means of the transversal lateral plates (64, 65), easily accessible from the sides of the structure (52), allows the placement of the mechanism for regulating the position of the working table (53), in the hydraulic press (1) of FIG. 6, to be implemented in a very simple manner and without the need for rollers or other accessories necessary, for example in classic solutions like the one depicted in FIG. 5 for guiding the cable (45) of the winch (44).

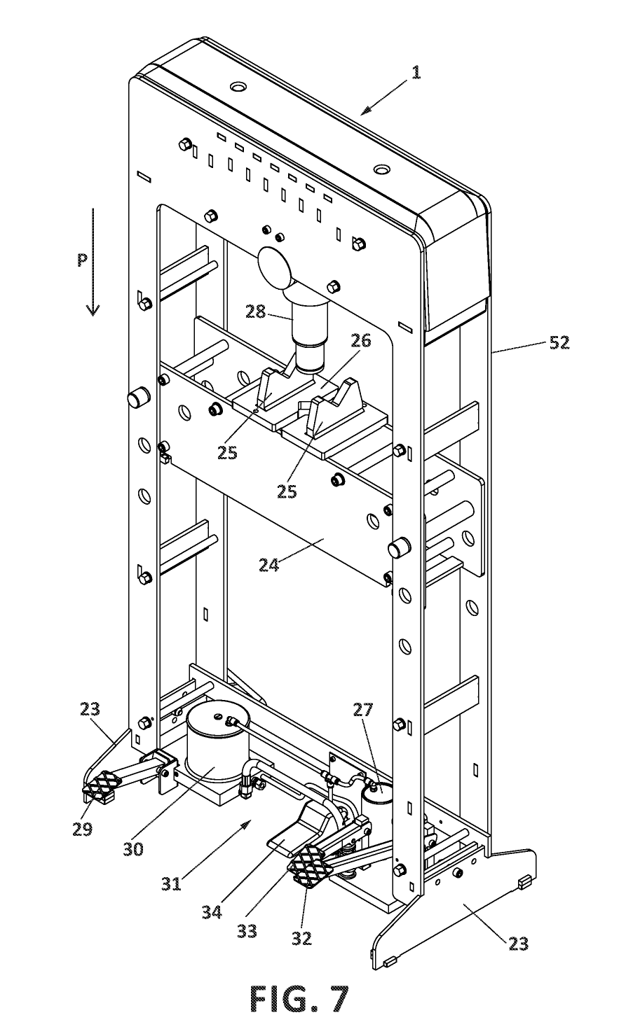

FIG. 7 shows a perspective of an embodiment of the hydraulic press (1) according to the invention, which allows the compression or manipulation of pieces. As can be seen in said figure, the hydraulic press (1) comprises a structure (52) which has at least one support (23) for supporting the hydraulic press (1) on the floor. The hydraulic press (1) also comprises a working table (24) which is the area of the hydraulic press (1) in which the piece intended to be compressed or manipulated by the hydraulic press (1) is arranged. More specifically, the piece is essentially arranged within a working space or area (26) on the working table (24). In the embodiment depicted, the working table (24) also comprises two seats (25), located within the working area (26) which serve as support for placing the piece to be manipulated. The piece intended to be compressed or manipulated, not depicted in FIG. 7, is generally placed on said seats (25). In order to be able to carry out the action of compressing or manipulating the pieces, the hydraulic press (1) also comprises a hydraulic pump (27) and a hydraulic cylinder (28). The function of the hydraulic pump (27) is to generate hydraulic energy from a power source and transmit the hydraulic energy to a hydraulic fluid which is displaced by means of a hydraulic circuit to the hydraulic cylinder (28). The hydraulic cylinder (28), in turn, receives hydraulic energy and converts it into mechanical energy, using said mechanical energy to effect an advance movement in a direction P towards the working area (26). Upon entering into contact with a piece placed in the working area (26), the hydraulic cylinder (28) is capable of continuing the advance thereof and exerting a compressive force which allows a manipulation task to be effected on the piece.

The hydraulic press (1) according to the invention is characterized in that it comprises a discharge pedal (29), the actuation of which causes a backward movement of the hydraulic cylinder (28) in a direction contrary to the direction P, making it possible for the operator to carry out the discharge operation of the hydraulic circuit. In the embodiment depicted in FIG. 7, the actuation of the discharge pedal (29) causes the opening of a discharge valve (not visible in FIG. 7) which allows the return of the hydraulic fluid towards a storage tank (30) and the backward movement of the hydraulic cylinder (28). Additionally, the hydraulic press (1) according to the invention is also characterized in that the discharge pedal (29) is situated in a lower area (31) of the structure (52) delimited by the supports (23), wherein said lower area (31) is easily accessible by the foot of an operator who is standing in front of the hydraulic press (1). In the embodiment depicted in FIG. 7, the hydraulic press (1) specifically has two supports (23), the lower area (31) being and delimited in the space between said supports (23). The natural working position of the operator is immediately in front of the hydraulic press (1) such that his feet are situated very close and even at least partially in the interior of the lower area (31) of the structure (52) and such that the actuation of the discharge pedal (29) is simple and convenient.

In order to facilitate the mounting of the discharge pedal (29) and minimize the connection elements required, optionally the tank (30) for storing the hydraulic fluid is situated in the lower area (31) of the structure (52) and the discharge pedal (29) is situated in a location adjacent to the tank (30). It is understood by adjacent location that the discharge pedal (29) and the tank (30) are very close to each other or attached as can be observed in FIG. 7.

Preferably, the hydraulic pump (27) of the hydraulic press (1) is situated in the lower area (31) of the structure (52). This location is advantageous because it facilitates the mounting and maintenance of the hydraulic pump (27) and allows pedals to be incorporated for the actuation thereof without the need for additional connection rods or elements of certain length. In the embodiment shown in FIG. 6, the existing connections between the elements of the hydraulic circuit located in the lower area (31) are not depicted, that is to say, the tank (30) and hydraulic pump (27) and the hydraulic cylinder (28) situated in the upper part of the hydraulic press (1). These connections, not depicted, of the hydraulic circuit are commonly integrated within the structure (52) of the hydraulic press (1).

Optionally, the hydraulic press (1) comprises a working pedal (32) for actuating the hydraulic pump (27) such that it causes the advance movement in the direction P of the hydraulic cylinder (28) towards the working area (26) and the application of the compressive force on the piece which is desired to be manipulated. This working pedal (32) facilitates the use of the hydraulic press (1) with a hydraulic pump, the actuation of which is of a manual type since by actuating only one pedal, the direct advance of the hydraulic cylinder (28) to the piece and the start of the application of the compressive force is achieved. Said working pedal (32) is situated in the lower area (31) of the structure (52), as is observed in FIG. 7, due to the advantages of accessibility and convenience previously mentioned for the discharge pedal (29). In this way, the hydraulic press (1) constitutes a very convenient alternative since it is not subject to the need to use manual levers for any of the pressing and discharging operations.

Optionally, the hydraulic press (1) comprises an inching pedal (33) in addition to comprising a working pedal (32). The actuation of the inching pedal (33) allows an advance movement to be caused in the direction P of the hydraulic cylinder (28) to approximate the working area (26) in a first step. The subsequent actuation of the working pedal (32), in a second step, causes the actuation of the hydraulic pump (32) to achieve the remaining advance of the hydraulic cylinder (28) to the piece and the start of the application of the compressive force. The presence of these two pedals, working pedal (32) and inching pedal (33) facilitates the use of the hydraulic press (1) with a hydraulic pump, the actuation of which is of a manual type with two speeds. Said inching pedal (33) is also situated in the lower area (32) of the structure (52), as is observed in FIG. 7, due to the advantages of accessibility and convenience previously commented for the rest of the pedals.

The hydraulic pump (27) of the embodiment shown can be actuated manually by means of the working and inching pedals (32, 33), however, it can also be actuated pneumatically. Thus, the hydraulic press (1) is provided with a pneumatic pedal (34), in addition to the pedals already described, which is also capable of causing the actuation of the hydraulic pump (27). The operator can then opt to: carry out a manual actuation by means of the combined use of the inching pedal (33) and the working pedal (32) or carry out a pneumatic actuation by means of the cited pneumatic pedal (34). The pneumatic actuation allows a greater working speed. The manual actuation is used when there is no compressed air available in the installation or for work which requires high precision. In hydraulic pumps with two speeds, like the one depicted in FIG. 7, the inching pedal (33) can be used in a vacuum, this is with initial low pressure, for a quick approach of the hydraulic cylinder (28) to the working area (26) with a high inching speed. The working pedal (32) is subsequently used and provides the effective pressure required for the manipulation work of the piece at a working speed lower than the inching speed.

As can also be observed in FIG. 7, the discharge pedal (29) is situated in the left part of the lower area (31) of the structure (52) while the actuation pedals (32, 33, 34) of the hydraulic pump (27) are situated in the right part of the lower area (31) of the structure and in locations adjacent to the hydraulic pump (27). The tanks (30) and the hydraulic pump (27) are adequately connected by means of different connection elements, for example fittings and hoses as is observed in FIG. 7. This separated arrangement of pedals to the left and right within the lower area (31), wherein the distance between the discharge pedal (29) and the actuation pedals (32, 33, 34) of the hydraulic pump (27) is, for example, in the order of 50 cm, has the advantage of contributing to preventing an unintended actuation of the pumping or discharge operations due to confusion on the part of the operator at the time of actuating the pedal corresponding to the desired operation. Thus, with the arrangement of pedals described, the operation of the hydraulic press (1) is more convenient and secure. Other embodiments are also considered, in 10 of which the arrangement of the pedals (29, 32, 33, 34) does not match the embodiment shown in FIG. 7.

1. A hydraulic press which is characterized in that it comprises:
a structure which comprises at least one support for supporting the hydraulic press on the floor,
a working table intended to house a set of pieces from which at least one piece is separated or removed by means of a compressive force exerted by the hydraulic press,
a collection area positioned below the working table for receiving the piece separated or removed from the set, and
a damper connected between the working table and the structure, wherein the damper is capable of being expanded to cause the ascent of the working table with respect to the structure and is capable of being compressed to allow the retained descent of the working table with respect to the structure.

2. The hydraulic press according to claim 1, which is characterized in that it comprises:
a tank for storing a hydraulic fluid,
a hydraulic pump for causing the advance of a hydraulic cylinder towards a working area,
and a discharge pedal for causing the backward movement of the hydraulic cylinder,
wherein the discharge pedal is situated in a lower area of the structure, wherein said lower area is delimited by the supports and is accessible by the foot of an operator who is standing in front of the hydraulic press.

3. The hydraulic press according to claim 1, which is characterized in that the working table comprises at least one connection element which allows the mounting of the collection area.

4. The hydraulic press according to claim 1, which is characterized in that the collection area is implemented in a tray separable from the hydraulic press.

5. The hydraulic press according to claim 3, which is characterized in that the separable element is a tray.

6. The hydraulic press according to claim 1, which is characterized in that the collection area comprises at least one housing which allows accessories or tools to be housed.

7. The hydraulic press according to claim 1, which is characterized in that the working table comprises at least one connection element which allows the mounting of the collection area, and in that said collection area is implemented in a tray separable from the hydraulic press, wherein the collection area also comprises at least one housing which allows accessories or tools to be housed.

8. The hydraulic press according to claim 1, which is characterized in that the structure comprises two opposed sides, the working table extending from one side to the other such that opposed sides of the working table are aligned with the opposed sides of the structure and in that the hydraulic press comprises a damper on each side of the structure, connected between the side of the structure and the side aligned with the working table.

9. The hydraulic press according to claim 1, which is characterized in that the damper is a gas cylinder provided with a body from which a longitudinally displaceable rod projects, wherein the body is connected to the working table while the rod is connected to the structure.

10. The hydraulic press according to claim 1, which is characterized in that it comprises at least one fixing element for fixing the working table to the structure.

11. The hydraulic press according to claim 1, which is characterized in that the damper is a damper with a lock.

12. The hydraulic press according to claim 1, which is characterized in that the structure comprises a fore frontal face and a rear frontal face between which a space is delimited within which the working table is placed at a regulatable height.

13. The hydraulic press according to claim 1, which is characterized in that the working table comprises a fore frontal plate, a rear frontal plate and at least one transversal lateral upper plate arranged between the fore frontal plate and the rear frontal plate wherein the damper is connected to said transversal lateral upper plate.

14. The hydraulic press according to claim 13, which is characterized in that the structure comprises at least one transversal lateral lower plate for connecting the damper such that the damper is connected between the transversal lateral upper plate of the working table and the transversal lateral lower plate of the structure, wherein said transversal lateral lower plate can be placed in a variable position of the structure.

15. The hydraulic press according to claim 14, which is characterized in that transversal lateral upper plate and the transversal lateral lower plate are parallel.

16. The hydraulic press according to claim 2, which is characterized in that the tank is situated in the lower area of the structure and in that the discharge pedal is situated in a location adjacent to the tank.

17. The hydraulic press according to claim 2, which is characterized in that the hydraulic pump is situated in the lower area of the structure.

18. The hydraulic press according to claim 2, which is characterized in that it comprises a working pedal for actuating the hydraulic pump, wherein said working pedal is situated in the lower area of the structure.

19. The hydraulic press according to claim 18, which is characterized in that the hydraulic pump is situated in the lower area of the structure and in that the discharge pedal is situated in the left part of the lower area, separated from the hydraulic pump, while the working pedal is situated in the right part of the lower area in a location adjacent to the hydraulic pump.

20. The hydraulic press according to claim 18, which is characterized in that it also comprises an inching pedal for actuating the hydraulic pump causing the partial advance of the hydraulic cylinder towards the working area, wherein said inching pedal is situated in the lower area of the structure.

21. The hydraulic press according to claim 20, which is characterized in that the hydraulic pump is situated in the lower area of the structure and in that the discharge pedal is situated in the left part of the lower area, separated from the hydraulic pump, while both the inching pedal and the working pedal are situated in the right part of the lower area in locations adjacent to the hydraulic pump.
